(19) United States
(12) Patent Application Publication
(10) Pub. No.: US 2001/0054848 A1
(43) Pub. Date: Dec. 27, 2001

(54) Method and apparatus for balancing the power losses in a number of parallel-connected cascode circuits

(75) Inventors: Eric Baudelot, Weisendorf (DE); Manfred Bruckmann, Nurnberg (DE); Heinz Mitlehner, Uttenreuth (DE); Benno Weis, Hemhofen (DE)

Correspondence Address: BAKER & BOTTS, 30 ROCKEFELLER PLAZA, NEW YORK, NY, 10112

(73) Assignee: SIEMENS AG.

(21) Appl. No.: 09/925,053

(22) Filed: Aug. 8, 2001

Related U.S. Application Data
(63) Continuation of application No. PCT/DE00/00219, filed on Jan. 26, 2000.

(30) Foreign Application Priority Data
Feb. 8, 1999 (DE) 19905078.3

(51) Int. Cl. H02J 3/46

(52) U.S. Cl. 307/24

(57) ABSTRACT

A method and an apparatus for balancing the power loss in at least two electrically parallel-connected cascode circuits, which each have a low-blocking semiconductor switch composed of silicon and a high-blocking-capability semiconductor switch composed of silicon carbide is disclosed. According to the present invention, an output voltage of each low-blocking-capability semiconductor switch is detected, with correction values being established as a function of them, and being superimposed on corresponding control signals for the low-blocking-capability semiconductor switches. An unbalanced current distributor can thus be actively balanced.

### FIELD OF THE INVENTION

The present invention relates to a method and an apparatus for balancing the power loss in at least two electrically parallel-connected cascode circuits, each of which has a low-blocking-capability semiconductor switch composed of silicon and a high-blocking-capability semiconductor switch composed of silicon carbide.

### BACKGROUND OF THE INVENTION

A a cascode circuit which has a low-blocking-capability semiconductor switch composed of silicon and a high-blocking-capability semiconductor switch composed of silicon carbide is known from German Patent 196 10 135. This cascode circuit has a normally off n-channel MOSFET, e.g. a low-voltage power MOSFET, and a high-blocking-capability junction field effect transistor (JFET). This cascode circuit is also referred to as a hybrid power MOSFET and is designed for a high blocking voltage of more than 600 V, while nevertheless having low loss when switched on.

The two FETs in this known cascode circuit are electrically connected in series in such a way that the source connection of the junction FET is electrically conductively connected to the drain connection of the MOSFET. Further, the gate connection of the junction FET is electrically conductively connected to the source connection of the MOSFET. The normally off n-channel MOSFET is composed of silicon. The normally off n-channel JFET is composed of silicon carbide.

The above-described cascode circuit is controlled by means of the gate voltage of the normally off MOSFET. When this MOSFET is switched on, its drain voltage is approximately zero. This drain voltage is fed back so that the gate voltage of the normally on JFET is also zero. In a normally on junction FET, the maximum drain current flows when the gate voltage is equal to zero. When the normally off MOSFET is switched off, its drain voltage rises, and the gate voltage of the normally on junction FET falls due to the feedback. As soon as the gate voltage of the junction FET reaches or falls below a threshold voltage, the drain current of this junction FET is zero. This cascode circuit is thus switched off.

In principle, these cascode circuits can be connected in parallel. When a number of semiconductor switches are connected in parallel, a problem occurs in that the load current to be carried is not shared uniformly between the parallel-connected semiconductor switches. This non-uniform current distribution results from production aspects of the semiconductor switch.

The problem of non-uniform current distribution in parallel-connected semiconductor switches will be explained using the example of a parallel circuit formed by two semiconductor switches, T1 and T2, which are two MOSFETs FIG. as shown in FIG. 1. FIG. 2 shows the associated output characteristics of these two MOSFETs T1 and T2 in the form of a graph. These output characteristics for the parallel-connected MOSFETs T1 and T2 are produced for two gate voltages which are the same. It can be seen from FIG. 2 that the output characteristics of the two MOSFETs T1 and T2 differ from one another when the gate voltage is the same. This discrepancy results from production. In the illustrated case, a load current of 1000 A/cm² is not split uniformly between the two parallel-connected MOSFETs T1 and T2. The MOSFET T1 carries a greater proportion of the current than the MOSFET T2. The MOSFET T1 carries a portion of the current I_{T1} of 600 A/cm², and the MOSFET T2 carries a portion of the current I_{T2} of 400 A/cm². Since the forward voltage across the two semiconductor switches T1 and T2 is the same since they are connected in parallel, the greater proportion of the current I_{T1} carried in the semiconductor switch T1 results in more power being lost at T1. Such an increased power loss can in some circumstances destroy, or at least damage, the semiconductor switch T1.

This problem can be solved by the overall current load level in a number of parallel-connected semiconductor switches being limited such that none of the parallel connector semiconductor switches is overloaded at a maximum unbalanced level guaranteed by the manufacturer. However, this solution has the disadvantage that the parallel circuit formed by a number of semiconductor switches has to be severely derated, and it is thus not very economical.

The semiconductor switches can be designed by the manufacturer to have a positive temperature coefficient. The publication “A New Generation of 600 V IGBT-Modules”, printed in the Conference Proceedings “POWER CONVERSION”, May 1998, pages 23 to 31, describes an IGBT module which has a positive temperature coefficient. This publication also states that such semiconductor switches can be used in a particularly advantageous manner in parallel circuits. A semiconductor switch designed in such a way does not allow the power loss in parallel-connected semiconductor switches to be balanced completely. Furthermore, this compensation mechanism involves a long time constant, by virtue of the positive temperature coefficients. Particularly in the case of bipolar semiconductor switches, this positive temperature coefficient requirement restricts the rest of the semiconductor switch optimization process. Using this method, the problem is only ameliorated, but is not completely solved.

This described problem occurs not only with parallel-connected MOSFETs T1 and T2 but, with any parallel-connected semiconductor switches. In a semiconductor circuit which is composed of two semiconductor switches, e.g. the cascode circuit described above, this problem cannot be solved by conventional means, since each semiconductor switch in a cascode circuit has been optimized for use in that cascode circuit.

### SUMMARY OF THE INVENTION

The present invention provides a method and an apparatus for balancing the power loss in a number of parallel-connected cascode circuits.

In accordance with the present invention, an output voltage of each low-blocking-capability semiconductor switch in the parallel-connected cascode circuits is detected, and then a signal is produced for the current flowing in the parallel-connected cascode circuits. Thus, the current distribution when a number of cascode circuits are connected in parallel is determined. This determined current distribution is balanced actively by making use of the fact that the output voltage of the low-blocking-capability power semiconductor switch varies with the control variable as a parameter. To this end, correction values are established as a function of the determined output voltages of the low-blocking-capability semiconductor switches in the parallel-connected cascode circuits, and are superimposed on corresponding control signals for the low-blocking-capability semiconductor switches. These correction values are used to vary the control signals for the low-blocking-capability semiconductor switches in a manner such that the output voltages of the parallel-connected cascode circuits are equal. The current distribution in this parallel circuit formed by a number of parallel-connected cascode circuits is thus balanced.

The present invention also provides an apparatus for balancing the power loss in a number of parallel-connected cascode circuits. For each cascode circuit the apparatus has a voltage measurement device, a device for establishing a correction value, and an adder. Each voltage measurement device is linked on the input side to a main connection and a reference connection of a low-blocking-capability semiconductor switch in a cascode circuit, and is linked on the output side to an input of the associated device for establishing a correction value. On the output side, each device is linked to a first input of an adder. A control signal for a corresponding low-blocking-capability semiconductor switch is applied to the second input of the adder. Since the output voltage of the low-blocking-capability semiconductor switch in each cascode circuit is determined, the voltage measurement device is not subject to any particular voltage requirements, even though a blocking voltage with a value of more than 600 V is applied to the cascode circuit. An apparatus of the present invention, using simple means, uses the current distribution in a number of parallel-connected cascode circuits to actively balance the cascode circuits.

In an advantageous method of the present invention, the determined correction values are not used to vary the control signals of the low-blocking-capability semiconductor switches in the parallel-connected cascode circuits, but are each supplied to a controllable decoupling device. Each of these controllable decoupling devices links a control connection of a high-blocking-capability semiconductor switch to a reference connection of its associated low-blocking-capability semiconductor switch. The determined correction values are used to modify the coupling levels between the high-blocking-capability and low-blocking-capability semiconductor switches in the parallel-connected cascode circuits in such a manner that the determined output voltages from the low-blocking-capability semiconductor switches are equalized, thus actively balancing the current distribution. In comparison to the previously known method, there is no voltage increase across the high-blocking-capability semiconductor switch, and there is no longer any increase in the voltage across the low-blocking-capability semiconductor switch in a cascode circuit.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 shows a parallel circuit formed by two MOSFETs;

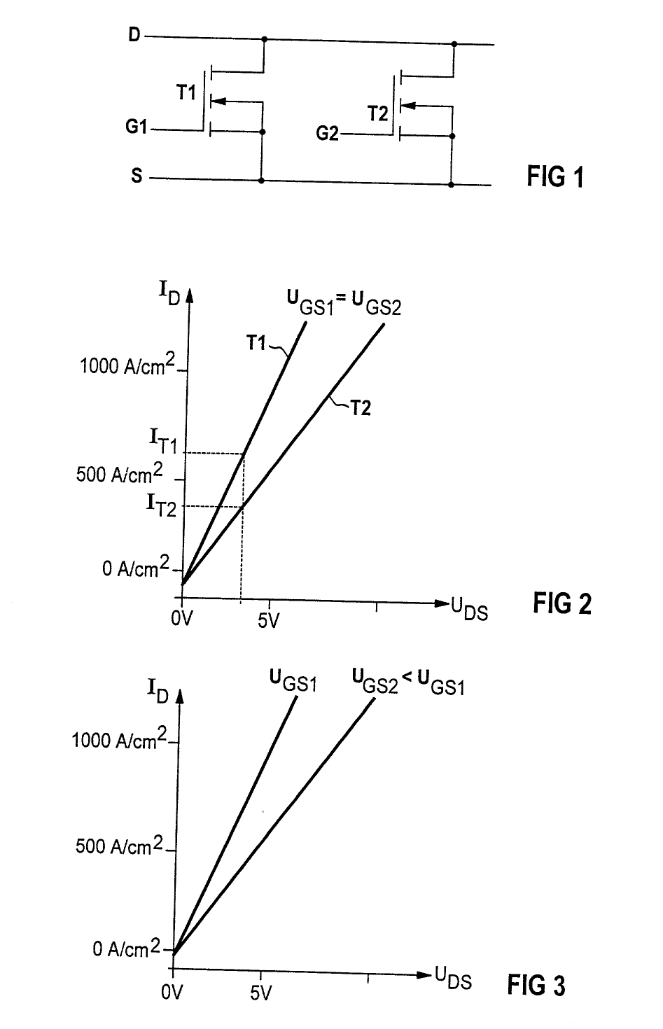

FIG. 2 shows the output characteristics of the MOSFETs shown in FIG. 1;

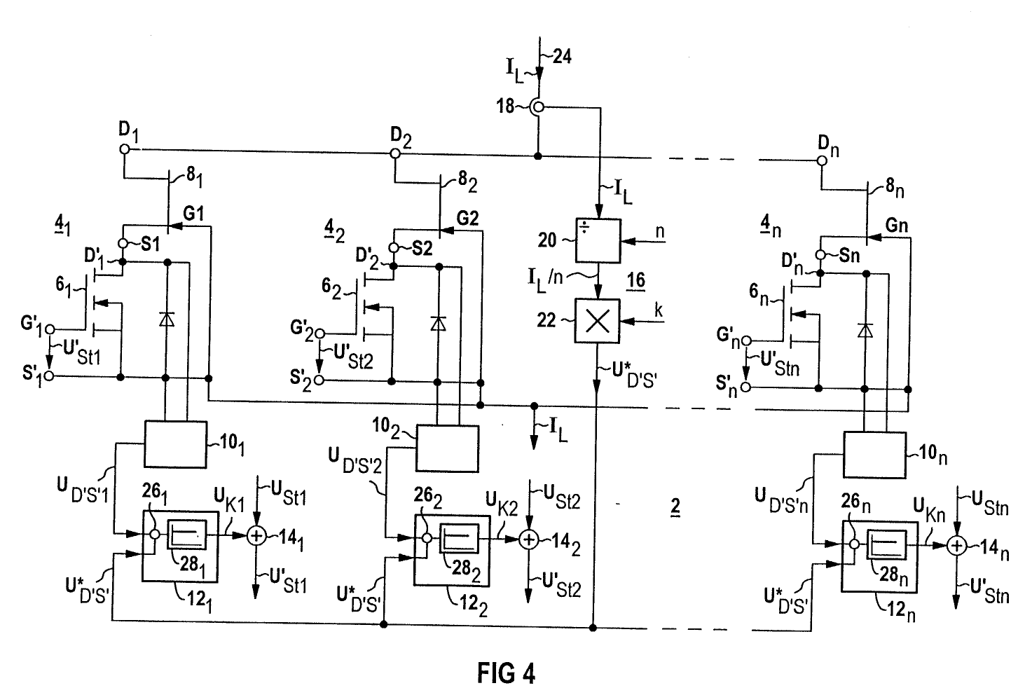

FIG. 3 shows the variation in the output characteristics of a MOSFET as a function of the control voltage;

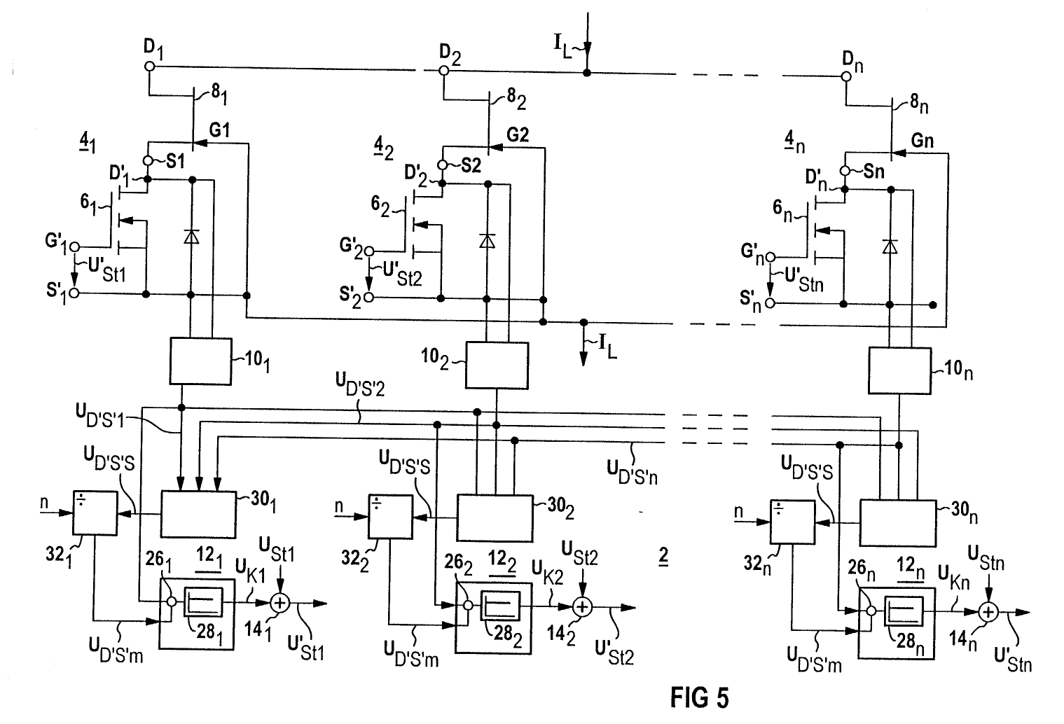

FIG. 4 illustrates an apparatus for balancing the power loss in a number of electrically parallel-connected cascode circuits, in accordance with an exemplary embodiment of the present invention;

FIGS. 5 and 6 each show one exemplary embodiment of the apparatus shown in FIG. 4;

FIG. 7 illustrates another embodiment of the apparatus according to the present invention; and

FIGS. 8 and 9 each show one exemplary embodiment of the apparatus shown in FIG. 7.

### DETAILED DESCRIPTION OF THE INVENTION

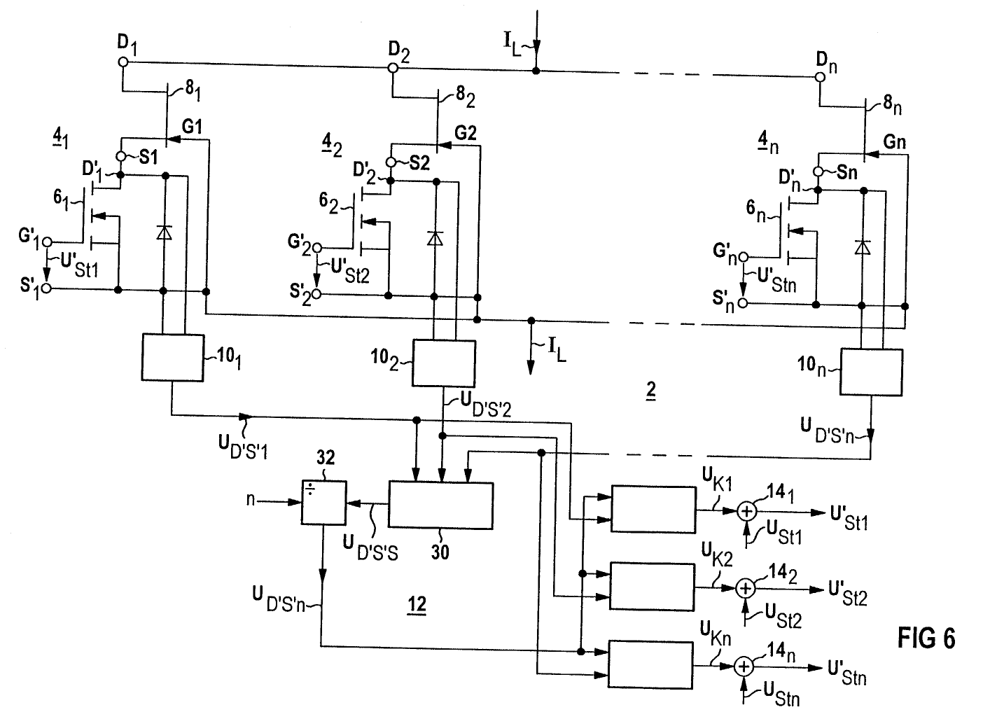

Now referring to the drawings, FIG. 4 shows a first exemplary embodiment of an apparatus 2 according to the invention for balancing the power loss in a number of cascode circuits 4₁, 4₂, . . . , 4ₙ. Each cascode circuit 4₁, 4₂, . . . , 4ₙ has a low-blocking-capability semiconductor switch 6₁, 6₂, . . . , 6ₙ, composed of silicon, and a high-blocking-capability semiconductor switch 8₁, 8₂, . . . , 8ₙ composed of silicon carbide. In the illustrated embodiment of FIG. 4, an n-channel MOSFET is provided with a low-blocking-capability semiconductor switch 6₁, 6₂, . . . , 6ₙ, in particular a low-voltage power MOSFET, and a junction FET, also referred to as a junction field effect transistor (JFET), is provided as the high-blocking-capability semiconductor switch 8₁, 8₂, . . . , 8ₙ. Thus, FIG. 4 shows a number of cascode circuits 4₁, 4₂, . . . , 4ₙ which are known from German Patent 196 10 135 and are electrically connected in parallel. To this end, the main connections D₁, D₂, . . . , Dₙ of the high-blocking-capability semiconductor switches 8₁, 8₂, . . . , 8ₙ and the reference connections S′₁, S′₂, . . ., S′ₙ of the parallel-connected cascode circuits 4₁, 4₂, . . . , 4ₙ are each electrically conductively connected. Each cascode circuit 4₁, 4₂, . . . , 4ₙ is driven by means of a control signal U_{St1}, U_{St2}, . . . , U_{Stn}, with this control voltage U_{St1}, U_{St2}, . . . , U_{Stn} being applied to a control connection G′₁, G′₂,. . . G′ₙ of the low-blocking-capability semiconductor switch 6₁, 6₂, . . . , 6ₙ. The control connection G₁, G₂, . . . , Gₙ of the high-blocking-capability semiconductor switch 8₁, 8₂, . . . , 8ₙ is electrically conductively connected to the reference connection S′₁, S′₂, . . . , S′ₙ of the cascode circuit 4₁, 4₂, . . . , 4ₙ.

As already mentioned and illustrated in FIG. 4, each cascode circuit 4₁, 4₂, . . . , 4ₙ has a MOSFET composed of silicon as the low-blocking-capability semiconductor switch 6₁, 6₂, . . . , 6ₙ and a JFET composed of silicon carbide as the high-blocking-capability semiconductor switch 8₁, 8₂, . . . , 8ₙ. Thus, in this embodiment, the cascode circuit 4₁, 4₂, . . . , 4ₙ is also referred to as a hybrid power MOSFET. An insulated gate bipolar transistor or a bipolar transistor can, in each case, be provided as the semiconductor switch 6₁, 6₂, . . . , 6ₙ composed of silicon and as the semiconductor switch 8₁, 8₂, . . . , 8ₙ composed of silicon carbide. It is also possible to provide a MOSFET in each case as the semiconductor switches 6₁, 6₂, . . . , 6ₙ and 8₁, 8₂, . . , 8ₙ

The apparatus 2 for balancing the power loss in a number of electrically parallel-connected cascode circuits 4₁, 4₂, . . . , 4ₙ has, for each cascode circuit 4₁, 4₂, . . . , 4ₙ, correction value U_{K1}, U_{K2}, . . . , U_{Kn}, and an adder 14₁, 14₂, . . . , 14ₙ. Further, this apparatus has a nominal value former 6. Each voltage measurement device 10₁, 10₂, . . . , 10ₙ is linked on the input side to a main connection D′₁, D′₂, . . . , D′ₙ and to a reference connection S′₁, S′₂, . . . , S′ₙ of an associated low-blocking-capability semiconductor switch 6₁, 6₂, . . . , 6ₙ. On the output side, each voltage measurement device 10₁, 10₂, . . . , 10ₙ is connected to an actual value input of the device 12₁, 12₂, . . . , 12ₙ. On the output side, this device 12₁, 12₂, . . . , 12ₙ is linked to a first input of an associated adder 14₁, 14₂, . . . , 14ₙ, to whose second input a control signal U_{St1}, U_{St}₂, . . . , U_{Stn} is applied.

The nominal value former 16 has a current measurement device 18, a divider 20 and a multiplier 22. The current measurement device 18 is arranged in the supply lead 24 to the parallel circuit comprising the n cascode circuits 4₁, 4₂, . . . , 4ₙ, and is linked on the output side to a first input of the divider 20. A number n is applied to the second input of this divider 20. On the output side, this divider 20 is connected to an input of the multiplier 22, to whose second input a proportionality factor k is applied. The output of this multiplier 12 is in each case linked to a nominal value input of the device 12₁, 12₂, . . . , 12ₙ for establishing a correction value U_{K1}, U_{K2}, . . ., U_{Kn}. The divider 20 is used to obtain an n-th part of this current from a measured load current I_{L}. This n-th part of the load current I_{L} flows through the n cascode circuits 4₁, 4₂, . . . , 4ₙ when the current distribution is balanced. This n-th part of the load current I_{L} is converted by the multiplier 22 and a proportionality factor k to a voltage value which is supplied as a nominal value U^{*}_{D′S′} to each device 12₁, 12₂, . . . , 12ₙ in the apparatus 2.

Each device 12₁, 12₂, . . . , 12ₙ for establishing a correction value U_{K1}, U_{K2}, . . . , U_{Kn} has a control loop, which comprises a comparator 26₁, 26₂, . . . , 26ₙ and a regulator 28₁, 28₂, . . . , 28ₙ. The inputs of the comparator 26₁, 26₂, . . . , 26ₙ are connected to the actual value input and to the nominal value input of the device 12₁, 12₂, . . . , 12ₙ. The output of the regulator 28₁, 28₂, . . . , 28ₙ is linked to the output of the device 12₁, 12₂, . . . , 12ₙ. In the illustration, the regulator 28₁, 28₂, . . . , 28ₙ is a P regulator. The regulator 28₁, 28₂, . . . , 28ₙ can also be a PI regulator.

Each determined correction value U_{K1}, U_{K2}, . . . , U_{Kn} is superimposed, by means of an adder 14₁, 14₂, . . . , 14ₙ, on a corresponding control signal U_{St1}, U_{St2}, . . . . , U_{Stn}. Each output of the n adders 14₁, 14₂, . . . , 14ₙ produces a corrected control signal U′_{St1}, U′_{St2}, . . . , U′_{Stn} which drives the low-blocking-capability semiconductor switch 6₁, 6₂, . . . , 6ₙ in the corresponding cascode circuit 4₁, 4₂, . . . , 4ₙ in such a manner that the output voltage U_{D′S′} of the low-blocking-capability semiconductor switch 6₁, 6₂, . . . , 6ₙ is increased or reduced as a function of the unbalance in such a way that the unbalance is cancelled out. This means that each output voltage U_{D′S′} of the low-blocking-capability semiconductor switches 6₁, 6₂, . . . , 6ₙ in the n cascode circuits 4₁, 4₂, . . . , 4ₙ is regulated to the predetermined nominal value U^{*}_{D′S′}.

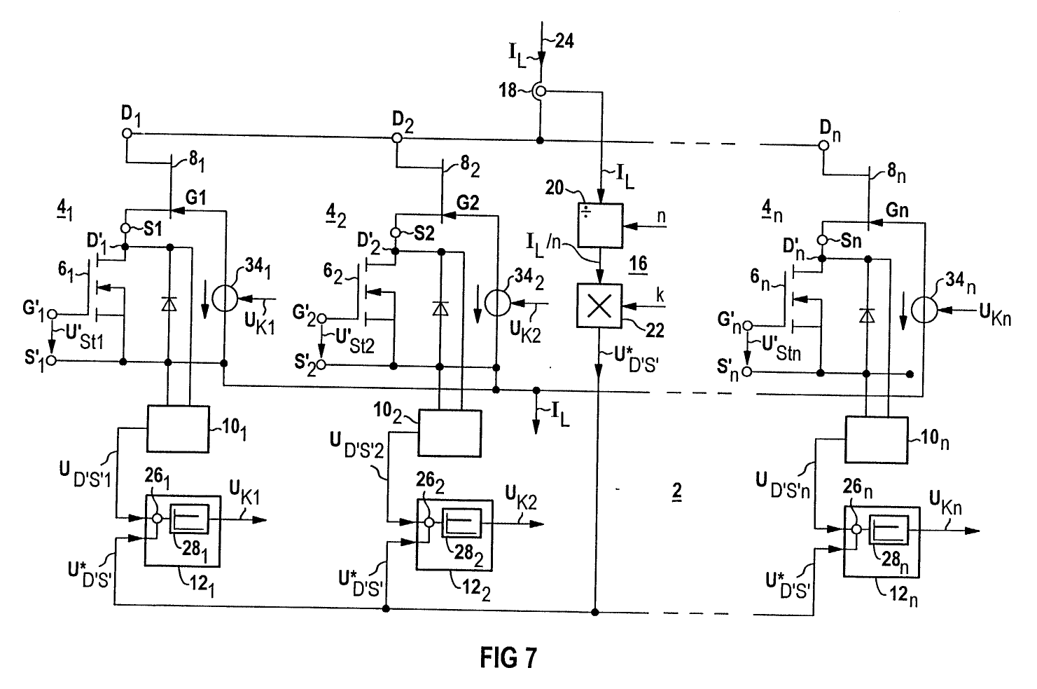

FIG. 5 shows, in more detail, an exemplary embodiment of the first embodiment of the apparatus 2 for balancing the power loss in a number of electrically parallel-connected cascode circuits 4₁, 4₂, . . . , 4ₙ as shown in FIG. 4. This embodiment differs from the embodiment shown in FIG. 4 in that no nominal value former 16 is used. To this end, each device 12₁, 12₂, . . . , 12ₙ has an adding device 30₁, 30₂, . . . , 30ₙ which has n inputs. Each input of this adding device 30₁, 30₂, . . . , 30ₙ forms an actual value input of a device 12₁, 12₂, . . . , 12ₙ, which is linked to an output of the n voltage measurement devices 10₁, 10₂, . . . , 10ₙ. On the output side, each adding device 30₁, 30₂, . . . , 30ₙ is linked to a divider 32₁, 32₂, . . . , 32ₙ, to whose second input a number n is applied. On the output side, each divider 32₁, 32₂, . . . , 32ₙ is connected to a nominal value input of an associated control loop, whose output forms an output of a device 12₁, 12₂, . . . , 12ₙ for establishing a correction value U_{K1}, U_{K2}, . . . , U_{Kn}. Each adding device 30₁, 30₂, . . . , 30ₙ and each divider 32₁, 32₂, . . . , 32ₙ each form a mean-value former.

FIG. 6 shows, in more detail, a further advantageous embodiment of the apparatus 2 for balancing, as shown in FIG. 4. In comparison to the embodiment shown in FIG. 5, the apparatus 2 in this embodiment has only one mean-value former instead of n mean-value formers, each comprising an adding device 30₁, 30₂, . . . , 30ₙ with a downstream divider 32₁, 32₂, . . . , 32ₙ. Otherwise, this embodiment is identical to the embodiment shown in FIG. 5.

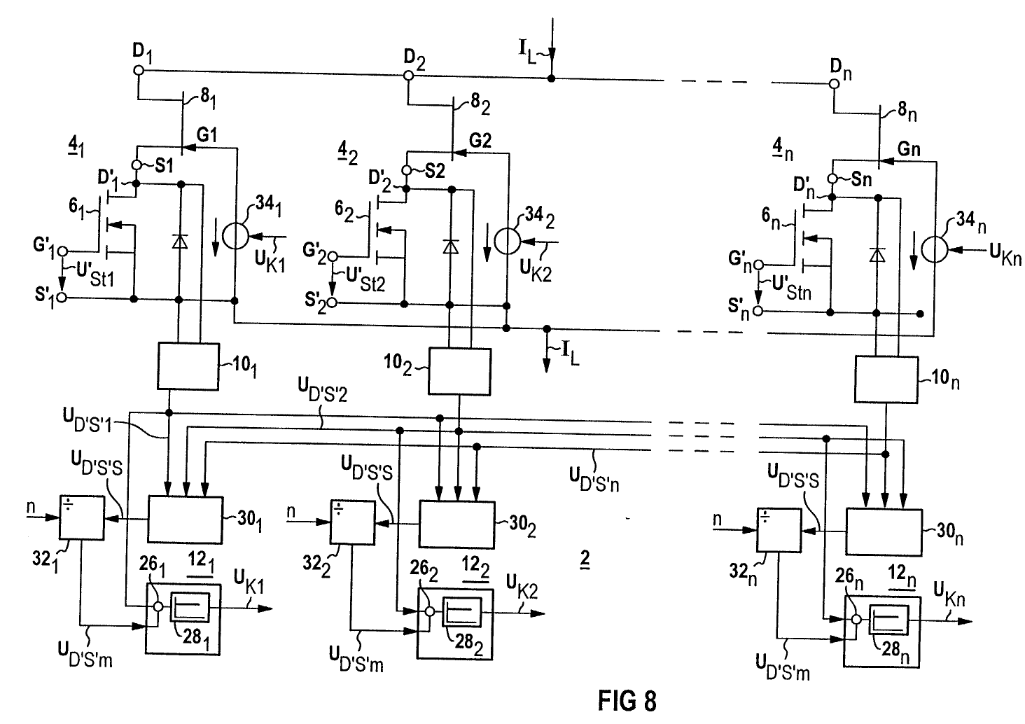

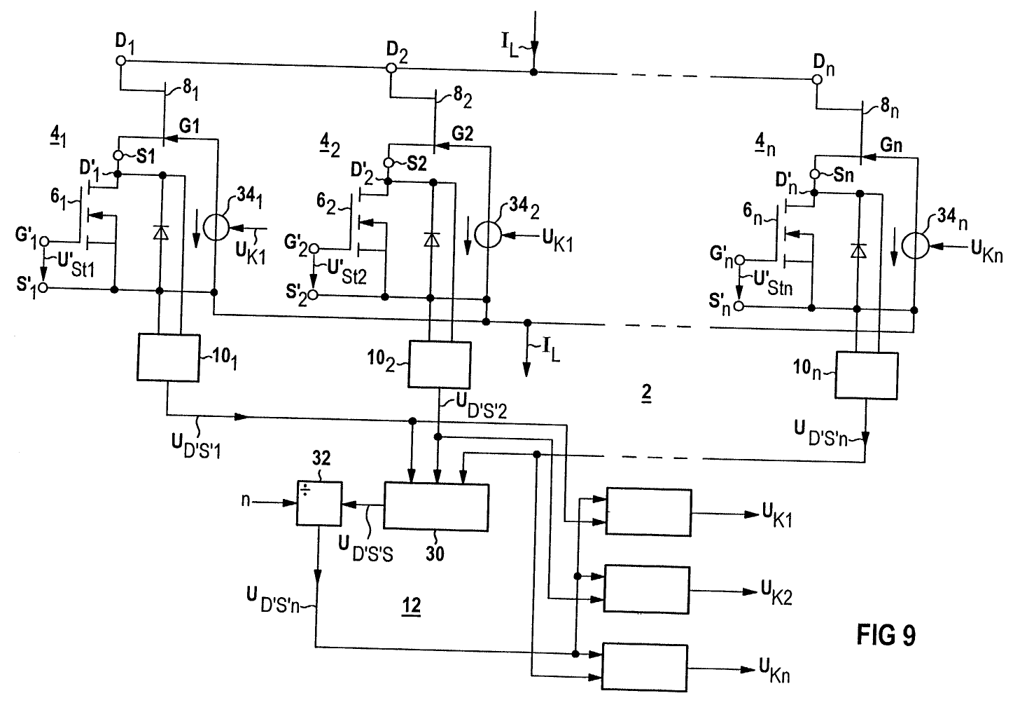

FIGS. 7 to 9 illustrate embodiments of the apparatus 2 for balancing the power loss in a number of electrically parallel-connected cascode circuits 4₁, 4₂, . . . , 4ₙ as shown in FIGS. 4 to 6, with each cascode circuit 4₁, 4₂, . . . , 4ₙ having a controllable decoupling device 34₁, 34₂, . . . , 34ₙ. This controllable decoupling device 34₁, 34₂, . . . , 34ₙ connects the control connection G₁, G₂, . . . , Gₙ of the high-blocking-capability semiconductor switch 8₁, 8₂, . . . , 8ₙ to the reference connection S′₁, S′₂, . . . , S′ₙ of the associated low-blocking-capability semiconductor switch 6₁, 6₂, . . . , 6ₙ. A controllable voltage source is provided as the controllable decoupling device 34₁, 34₂, . . . , 34ₙ. If a resistor is connected electrically in series with the controllable voltage source, then this controlled voltage source generates a current value as a function of the resistance. This embodiment is required for current-controlled semiconductor switches 8₁, 8₂, . . . , 8ₙ in the cascode circuit 4₁, 4₂, . . . , 4ₙ.

The embodiment of the apparatus 2 shown in FIGS. 7 to 9 differs by virtue of the use of the controlled decoupling device 34₁, 34₂, . . . , 34ₙ from the embodiments of the apparatus 2 shown in FIGS. 4 to 6 in that there is no longer any need for any adders 14₁, 14₂, . . . , 14ₙ. The correction values U_{K1}, U_{K2}, . . . , U_{Kn} generated by the device or devices 12 or 12₁, 12₂, . . . , 12ₙ are supplied to the associated controlled decoupling devices 34₁, 34₂, . . . , 34ₙ. Otherwise, the apparatuses 2 shown in FIGS. 7 to 9 correspond to the apparatus 2 shown in FIGS. 4 to 6. The use of the n controlled decoupling devices 34₁, 34₂, . . . , 34ₙ in a parallel circuit of n cascode circuits 4₁, 4₂, . . . , 4ₙ results in an increased forward voltage in each case being dropped across the high-blocking-capability semiconductor switches 8₁, 8₂, . . . , 8ₙ in the cascode circuits 4₁, 4₂, . . . , 4ₙ.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

We claim:

1. A method for balancing the power loss in at least two electrically parallel-connected cascode circuits, each of which have a low-blocking-capability semiconductor switch composed of silicon and a high-blocking-capability semiconductor switch composed of silicon carbide, said method comprising:
detecting an output voltage of each low-blocking-capability semiconductor switch in said parallel-connected cascode circuits;
establishing correction values being established as a function of said detected output voltages; and
superimposing said correction values on corresponding control signals for each of said low-blocking-capability semiconductor switches in said parallel-connected cascode circuits.

2. A method for balancing the power losses in at least two electrically parallel-connected cascode circuits, each of which have a low-blocking-capability semiconductor switch composed of silicon and a high-blocking-capability semiconductor switch composed of silicon carbide, said method comprising:
linking one control connection of said high-blocking-capability semiconductor switch to a reference connection of its corresponding low-blocking-capability semiconductor switch by means of a controllable decoupling device;
detecting an output voltage of each low-blocking-capability semiconductor switch in said parallel-connected cascode circuits; and
establishing correction values as a function of said detected output voltages, and supplying said correction values to corresponding controllable decoupling devices.

3. The method as claimed in claim 1 or 2, wherein said detected output voltages are each compared with a predetermined output voltage mean value, and with a correction value being established from each determined control error.

4. The method as claimed in claim 1 or 2, wherein said detected output voltages are each compared with a predetermined nominal value, and with a correction value being established from each determined control difference.

5. The method as claimed in claim 3, wherein said detected output voltages are added up in order to establish an output voltage mean value, and a sum values are divided by the number of detected output voltages (U_{D′S′1}, . . . , U_{D′S′}ₙ).

6. The method as claimed in claim 4, wherein a total current for said parallel-connected cascode circuits is measured in order to establish a nominal value, and subsequently dividing said nominal value by the number of parallel-connected cascode circuits and multiplied by a proportionality factor.

7. An apparatus for balancing the power loss in at least two electrically parallel-connected cascode circuits, which each have a low-blocking-capability semiconductor switch composed of silicon and a high-blocking-capability semiconductor switch composed of silicon carbide, said apparatus comprising:
a voltage measurement device for each cascode circuit; and
a device for establishing a correction value for each cascode circuit, and an adder for each cascode circuit, with each of said voltage measurement devices being linked on the input side to a main connection and to a reference connection blocking-capability semiconductor switch, and being linked on an output side to an input of a corresponding device, and with each of said devices for establishing a correction value being connected on an output side to an input of a corresponding adder, wherein a control signal is applied to a second input of said adder to whose second input a control signal is applied.

8. An apparatus for balancing the power loss in at least two electrically parallel-connected cascode circuits, which each have a low-blocking-capability semiconductor switch composed of silicon and a high-blocking-capability semiconductor switch composed of silicon carbide, said apparatus comprising:
a control connection of said high-blocking-capability semiconductor switches linked by means of a controllable decoupling device to a reference
connection of its corresponding low-blocking-capability semiconductor switch; and
a voltage measurement device for each cascode circuit and a device for establishing a correction value for each cascode circuit, wherein each voltage measurement device is linked on the input side to a main connection and to a reference connection of a low-blocking-capability semiconductor switch, and being linked on the output side to an input of a corresponding device, and wherein each device for establishing a correction value is connected on the output side to a control input of a corresponding controllable decoupling device.

9. The apparatus as claimed in claim 7 or 8, with each of said devices for establishing a correction value comprises a control loop in order to establish said correction value, wherein said device for establishing a correction value is linked on the input side to an output of a nominal value former and to an output of a corresponding voltage measurement device and with the control loop having a comparator with a downstream regulator.

10. The apparatus as claimed in claim 7 or 8, with each device for establishing a correction value on an input side comprising an adding device with a number of inputs and on an output side, a control loop which is linked on the input side by means of a divider to an output of said adding device and to an input of said adding device, with the number of parallel-connected cascode circuits being applied to a second input of said divider, and with the control loop having a comparator with downstream regulators.

11. The apparatus as claimed in claim 7 or 8, with a device for establishing a number of correction values comprising, on an input side, an adding device with a number of inputs and comprising, on an output side, a number of control loops, with said adding device having a downstream divider which is in each case connected on said output side to an input of the control loop, with a second input of the number of control loops in each case being linked to an input of said adding device and with each control loop having a comparator with a downstream regulator.

12. The apparatus as claimed in claim 9, wherein nominal value former comprises a current measurement device, a divider and a multiplier, wherein said divider is linked to an output of the current measurement device to an input of the multiplier, and wherein the number of parallel-connected cascode circuits are applied to a second input of the divider, and a proportionality factor being applied to a second input of the multiplier.

13. The apparatus as claimed in claim 7 or 8, wherein said low-blocking-capability semiconductor switch is a MOSFET.

14. The apparatus as claimed in claims 7 or 8, wherein said high-blocking-capability semiconductor switch is a junction FET.

15. The apparatus as claimed in claims 7 or 8, wherein said low-blocking-capability semiconductor and said high-blocking-capability semiconductor switches are each an bipolar transistor.

16. The apparatus as claimed in claims 7 or 8, wherein said low-blocking-capability semiconductor and said high-blocking-capability semiconductor switches are each an insulated gate bipolar.
